(19) United States
(12) Patent Application Publication
(10) Pub. No.: US 2006/0206763 A1
(43) Pub. Date: Sep. 14, 2006

(54) Debugging system, semiconductor integrated circuit device, microcomputer, and electronic apparatus

(75) Inventor: Makoto Kudo, Fujimi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/350,291

(22) Filed: Feb. 8, 2006

(30) Foreign Application Priority Data
Mar. 9, 2005 (JP) 2005-065552

(51) Int. Cl. G06F 11/00

(52) U.S. Cl. 714/30

(57) ABSTRACT

A debugging system, comprising a pin-saving type debug tool and a target system to be a debug target of the debug tool, the target system includes: an integrated circuit device incorporating a CPU and an inner debug module, the inner debug module having a function to carry out asynchronous communication with the pin-saving type debug tool thereby to carry out on-chip debugging, wherein the integrated circuit device includes a first clock generation circuit; and a first asynchronous-communication control circuit that carries out communication control for carrying out transmission and reception of debug data to/from the pin-saving type debug tool, through asynchronous type serial data transmission, with a clock generates in a first clock generation circuit being as an operation clock, and wherein the pin-saving type debug tool includes a second clock generation circuit that generates a clock with the same baud rate as that of the first clock generation circuit; and a second asynchronous-communication control circuit that carries out the transmission and reception of debug data to/from the target system, through asynchronous type serial data transmission, with a clock generated in the second clock generation circuit being as an operation clock.

### BACKGROUND

1. Technical Field

The present invention relates to debugging systems, semiconductor integrated circuit devices, microcomputers, and electronic apparatus.

2. Related Art

In recent years, there is increasing the demand for microcomputers which are built in electronic apparatus, such as game devices, car-navigation systems, printers, and personal digital assistants, and with which advanced information processing can be realized. Such a built-in type microcomputer is generally mounted in a user board called a target system. Then, in order to support development of the software that operates this target system, a pin-saving type debug tool (a software development support tool), such as in-circuit emulator (ICE) is widely used.

Now, as for such ICE, conventionally, ICE called a CPU replacement type as shown in FIG. 19 has been mainstream. In this CPU replacement type ICE, a microcomputer 302 is removed from a target system 300 at the time of debugging, and instead a probe 306 of a debug tool 304 is coupled. Then, this debug tool 304 is caused to emulate the operation of the removed microcomputer 302. Moreover, this debug tool 304 is caused to carry out various processing required for debugging.

However, this CPU replacement type ICE has a drawback that the count of lines 308 of the probe 306 increases as the pin count of the probe 306 increases. For this reason, it is difficult to emulate high-frequency operation of the microcomputer 302 (e.g., limited to around 33 MHz). Moreover, the design of the target system 300 also becomes difficult. Furthermore, the operation environment (timings and load conditions of the signal) of the target system 300 differs between at the time of actual operation in which the microcomputer 302 is mounted and operated, and at the time of a debug mode in which the operation of the microcomputer 302 is emulated with the debug tool 304. Moreover, this CPU replacement type ICE also has a problem that for different microcomputers, differently designed debug tools and probes with different pin counts and different pin positions need to be used even if they are the derivative products.

On the other hand, as ICE to resolve such drawbacks of the CPU replacement type ICE, there is known ICE of such a type in which the debug pins and functions for realizing the same function as that of the ICE are mounted on a mass-production chip. For example, as such a debug function mounting type ICE, there is known microcomputers that incorporate an inner debug module, the inner debug module carrying out clock synchronous communication with the pin-saving type debug tool (ICE or the like) and having an on-chip debug function to carry out debug commands inputted from the debug tool.

In such a case, the microcomputer carries out debugging through clock synchronous communication with the debug tool.

In this case, between the debug tool and microcomputer, there are required: a break input from the debug tool to the microcomputer; a break/run input from the microcomputer to the debug tool; data (debug commands, or the like) communication to the microcomputer from the debug tool; data communication from the microcomputer to the debug tool; a communication synchronous clock between an input debug tool and the microcomputer; a plurality of communication pins for additional information, such as a trace to the debug tool from the microcomputer; and terminals (pins), such as a ground line between the input debug tool and microcomputer.

JP-A-8-255096 is a first example of related art.

JP-A-11-282719 is a second example of related art.

Although the debug terminals (pins) will increase rapidly as summing up such terminals (pins), it is preferable that terminals required only at the time of debugging and unneeded for end users be as less as possible. Moreover, the increase of the terminal (pin) count of the microcomputer PKG will lead to the cost increase or the like of ICs.

Furthermore, the pin count between the board and debug tool will increase, the design difficulty of the board will increase, thereby reducing the reliability and inviting the increase of the development cost of the board and system and the increase in the development time.

### SUMMARY

An advantage of the invention is to provide a debugging system, a target system, an integrated circuit device, or the like, which further save the terminals unnecessary for end users in the target system of a type in which the debug pins and functions are mounted on a mass-production chip.

(1) According to an aspect of the invention, the debugging system comprises a pin-saving type debug tool, and a target system to be a debug target of the debug tool. The target system includes: an integrated circuit device incorporating a CPU and an inner debug module, the inner debug module having a function to carry out asynchronous communication with the pin-saving type debug tool thereby to carry out on-chip debugging, wherein the integrated circuit device includes a first clock generation circuit; and a first asynchronous-communication control circuit that carries out communication control for carrying out transmission and reception of debug data to/from the pin-saving type debug tool, through asynchronous type serial data transmission, with a clock generated in a first clock generation circuit being as an operation clock, and wherein the pin-saving type debug tool includes: a second clock generation circuit that generates a clock with the same baud rate as that of the first clock generation circuit; and a second asynchronous-communication control circuit that carries out communication control for carrying out the transmission and reception of the debug data to/from the target system, through asynchronous type serial data transmission, with a clock generated in the second clock generation circuit being as an operation clock.

In this case, the CPU needs to be just a circuit having a processor function, and circuits having different names but having the processor function are within the scope of the invention.

Here, a substrate includes a user board, a printed circuit board, or the like. In addition, integrated circuit devices such as memories and others, in addition to the integrated circuit device (microcomputers or the like) with a built-in CPU, may be mounted in the substrate. The pin-saving type debug tool refers to, for example, ICE or the like.

The first asynchronous-communication control circuit and second asynchronous-communication control circuit transmit and receive the debug data through asynchronous type serial data transmission.

The serial data transmission is a method for transmitting bits one by one between two apparatus (computers or the like).

Moreover, the asynchronous system is a system in which a transmitting station generates data bits based on its own reference timing signal and transmits them including, for every fixed bits, an identification signal to serve as a mutual reference, by using a communication method in which the timings between the transmission and reception do not necessarily agree with each other, so that a receiving station recognizes the start of this signal and brings in a data code.

The invention may be a start-stop synchronization type, which is an example of the asynchronous types. In the start-stop synchronization type, a start bit is inserted immediately before each code, and a stop bit immediately after the each code, and an idle state (a condition in which data is not being transmitted) is the same condition as that of the consecutive stop bits. Accordingly, upon detection of the start bit from the idle state, the receiving station recognizes this as the start of the receiving data and starts to bring in as the data. Then, upon confirmation of the stop bit, which is the end bit of a mutually predetermined length of bits, the receiving station will wait for a start bit to be the start of the next data.

The first asynchronous-communication control circuit and second asynchronous-communication control circuit may convert into a serial bit stream a byte data coming from a parallel bus in the integrated circuit device or debug module, and at the same time carry out the processing for converting a bit stream, which comes into a serial port via an external cable, into a parallel byte data that the computer can process.

Moreover, in addition to the serial to parallel conversion, processing for converting (changing) the voltages used for indicating the bit sequence may be also carried out. Before the byte data is transmitted, additional bits (the so-called start bit and stop bit) may be added to the respective byte.

According to the invention, the target system and debug module transmit and receive the debug data through asynchronous serial data transmission at the time of debugging. Accordingly, because it is not necessary to transmit and receive a clock used for synchronization like in the case of transmitting and receiving data through synchronous transmission at the time of debugging, it is not necessary to have a clock terminal for debugging.

Here, the debug data includes, for example, debug commands to be transmitted to the target system from the debug module, and data and status commands to be transmitted to the debug module from the target system.

Thus, according to the invention, the terminals (pins), which are used only in the debug mode in the integrated circuit device having a built-in CPU and are not used in the user mode (in user programs), can be reduced and therefore the cost increase of the integrated circuit device can be prevented.

(2) In the debugging system of the invention, it is preferable: that the integrated circuit device of the target system include a debug terminal to which one communication line for transmitting and receiving the debug data through half duplex bidirectional communication is coupled; that the first asynchronous-communication control circuit carry out communication control for transmitting and receiving the debug data, through half duplex bidirectional communication, via the pin-saving type debug tool and the communication line; that the pin-saving type debug tool include a debug terminal to which one communication line for transmitting and receiving the debug data through half duplex bidirectional communication is coupled; and that the second asynchronous-communication control circuit carry out communication control for transmitting and receiving the debug data, through half duplex bidirectional communication, via the integrated circuit device and the communication line.

According to the invention, the target system and the debug module transmit and receive the debug data through half duplex bidirectional communication at the time of debugging. In the case of serial communication, one communication line required for transmission and reception of the debug data is sufficient, and as for the integrated circuit device one terminal for transmission and reception of the debug data is sufficient.

In transmitting and receiving the debug data through half duplex bidirectional communication, for example, the data size from the debug module to the integrated circuit device and the data size from the integrated circuit device to the debug module may be fixed to transmit and receive the data through handshaking.

(3) In the debugging system of the invention, it is preferable that the first clock generation circuit of the integrated circuit device of the target system include a frequency dividing circuit that divides a clock and generates a clock with a predetermined baud rate based on a clock selection value, which can be set or changed from the outside; and that the second clock generation circuit of the pin-saving type debug tool include a frequency dividing circuit that divides a clock and generates a clock with a predetermined baud rate based on a clock selection value, which can be set or changed from the outside.

The clock selection value in the first clock generation circuit or the second clock generation circuit may be realized by providing a clock selection value register that is rewritable through an external input.

For example, in the debug tool, the value of the clock selection value storing register may be set or changed based on the external input from an operator or the like.

Moreover, in the integrated circuit device of the target system, the value of the clock selection value storing register may be set or changed by a write command or the like from the debug module.

According to the invention, the value (for example, the initial value) of the clock selection value is typically set to such a clock selection value that generates a clock with a low baud rate, and in the case where high-speed data transmission is required, the value of the clock selection value may be changed as to increase the baud rate.

(4) In the debugging system of the invention, it is preferable that a general-purpose UART incorporated in the integrated circuit device be used as the first asynchronous-communication control circuit of the integrated circuit device.

The objectives of UART (Universal Asynchronous Receiver Transmitter) are converting into a serial bit stream the byte data coming from the parallel bus of PC, and converting a bit stream, which enters the serial port via the external cable, into a parallel byte data that the computer can process.

In addition to the serial to parallel conversion, UART may carry out processing for converting (changing) the voltages used for indicating the bit sequence. Before the byte data is transmitted, additional bits (the so-called start bit and stop bit) may be added to the respective byte.

Such UART is a chip for serial communication and is usually incorporated in a mother board (or an internal modem card) of PC (an integrated circuit device).

In the invention, the first asynchronous-communication control circuit is realized using this general-purpose UART. Accordingly, it is not necessary to additionally prepare a circuit for debugging, and therefore the increase of the circuit size of the integrated circuit device can be prevented.

(5) In the debugging system of the invention, it is preferable that the first asynchronous-communication control circuit of the integrated circuit device and the second asynchronous-communication control circuit of the pin-saving type debug tool operate through handshaking under a predetermined standard.

For example, the half duplex bidirectional communication may be realized by carrying out handshaking with a predetermined data size between the debug module and the integrated circuit device under the predetermined standard for carrying out asynchronous communication (for example, RS232C, which is a standard for the serial communication).

(6) In the debugging system of the invention, it is preferable that the substrate of the target system and the pin-saving type debug tool be grounded.

The substrate may be directly grounded or may be indirectly grounded via a plug socket or the like.

Usually, unless the ground is coupled to be a same potential, HL level will differ and the communication can not be made. In particular, in case of high speed, a plurality of ground lines need to be coupled. However, if the baud rate at the time of debugging is on the order of a frequency of 9600 bit/second (10 KHz), a weak ground line is sufficient and a dedicated ground line is unnecessary. Moreover, if the pin count used at the time of debugging is small like in the invention, the value of flowing electric current becomes small, the power consumption decreases, and therefore omission of the ground line will not cause any problems in the operation.

With the invention, the ground line for coupling the substrate of the target system to the pin-saving type debug tool can be omitted, allowing the pin count of the substrate to be reduced.

In addition, as the frequency is reduced, the power consumption can be reduced, which is more desirable, and therefore at the time of debugging, the operation may be carried out at a low frequency.

(7) The invention is any one of the integrated circuit devices described above.

(8) According to another aspect of the invention, a microcomputer includes the integrated circuit device described above.

(9) According to another aspect of the invention, electronic apparatus includes: the microcomputer described above; an input source for data to be a processing target of the microcomputer described above; and an output device for outputting the data processed by the microcomputer described above.

### BRIEF DESCRIPTION OF THE DRAWINGS

The invention will be described with reference to the accompanying drawings, wherein like numbers refer to like elements.

FIG. 1 is a view for explaining the configuration of a target system, a debugging system, and a microcomputer of the embodiment.

FIG. 2 is a view for explaining an example of the configuration of the target system of the embodiment.

FIG. 3A is an example of address allocation for each register of a debug module, and FIG. 3B is a table showing an example of the relationship between a value of a clock selection register and a frequency dividing ratio.

FIG. 4 is a view for explaining an example of the configuration of a debug tool of the embodiment.

FIG. 5 is a view for explaining an example of a communication specification of debug commands of the embodiment.

FIG. 6 is a timing chart indicating the relationship between CPU clock 31 and an asynchronous-control circuit clock 79 of the embodiment (at the time of ½ frequency dividing).

FIG. 7 is a timing chart concerning the judgment of 1 bit of transmitting and receiving data in the asynchronous-control circuit.

FIG. 8 is a timing chart concerning the judgment of 1 byte of the transmitting and receiving data in the asynchronous-control circuit.

FIG. 9 is a timing chart concerning an input and output control of transmission and reception.

FIG. 10A through FIG. 10C are views showing an example of SIO operation for each command.

FIG. 11 is a flow chart of the operation at the time of debug processing in a microcomputer of the target system.

FIG. 12 is a flow chart of the operation at the time of debug processing in the debug tool.

FIG. 13 is a view for explaining a baud-rate switching control for communication data.

FIG. 14 is a flow chart of the switching operation of an operation clock in the debug tool.

FIG. 15 is a view for explaining another configuration of the target system, the debugging system, and the microcomputer of the embodiment.

FIG. 16 is an example of a hardware block diagram of the microcomputer of the embodiment.

FIG. 17 is an example of a block diagram of electronic apparatus including the microcomputer.

FIG. 18A, FIG. 18B, and FIG. 18C are examples of the outline views of various electronic apparatus.

FIG. 19 is an example of ICE called a CPU replacement type, which is a conventional type.

### DESCRIPTION OF EXEMPLARY EMBODIMENTS

Hereinafter, suitable embodiments of the invention are described in detail using the accompanying drawings.

1. Features of the Embodiments

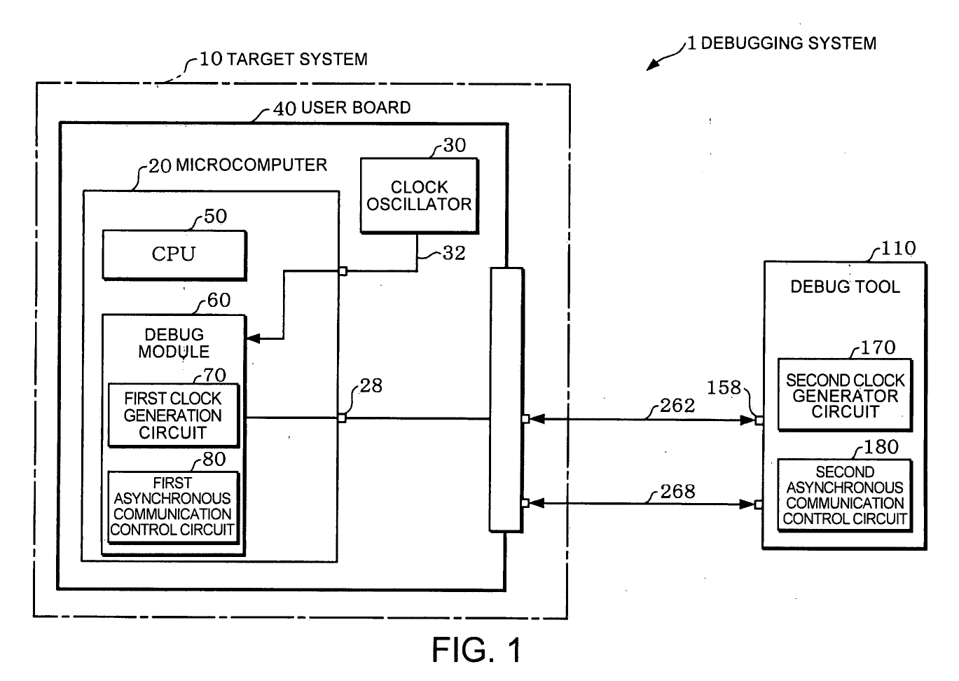

FIG. 1 is a view for explaining the configuration of a target system, a debugging system, and a microcomputer of the embodiment.

A debugging system 1 of the embodiment includes a pin-saving type debug tool (ICE or the like) 50, and a target system 10 to be the debug target of the debug tool 50.

In the target system 10, a microcomputer (an example of integrated circuit devices including CPU) 20 is mounted in a substrate (a user board) 40. In the substrate (the user board) 40, semiconductor integrated circuit devices such as memories, and an oscillator (a clock oscillator) 30 such as a crystal oscillator to generate and output a digital clock, may be mounted in addition to the microcomputer 20.

The microcomputer 20 incorporates a CPU 50, and a debug module 60 having a function to carry out asynchronous communication with a pin-saving type debug tool 110 and carry out on-chip debugging.

The debug module 60 includes a first clock generation circuit 70, and a first asynchronous-communication control circuit 80 that carries out communication control for transmitting and receiving debug data to/from the pin-saving type debug tool 110, through asynchronous type serial data transmission, with a clock generated in the first clock generation circuit 70 being as an operation clock.

Moreover, the microcomputer includes CPU 50.

The CPU 50 carries out execution process of various commands, and includes an internal register. The internal register includes general-purpose registers R0 through R15, and special registers; SP (stack pointer register), AHR (a high register for sum-of-products result data), ALR (a low register for the sum-of-products result data), or the like. Moreover, CPU 22 executes a user program in the user mode, and executes a monitor program and a debug command in the debug mode.

The debug module 24 includes ROM, RAM, a control register, or the like, and carries out various kinds of processing (I/O interface with the debug module, analysis of the debug command, an interrupt processing from the user program to the monitor program, or the like) required for causing CPU 22 to execute the monitor program and debug commands in the debug mode.

Moreover, the microcomputer includes a debug terminal 28, to which one communication line 62 for transmitting and receiving debug data through half duplex bidirectional communication is coupled.

The first asynchronous-communication control circuit 80 transmits and receives the debug data to/from the pin-saving type debug tool 110, via the communication line 62, through half duplex bidirectional communication.

A monitor program is stored in ROM of the debug module 60. The contents of the internal register of CPU 50 are saved into RAM at the time of transition to the debug mode (when a break in the user program occurs). This allows the execution of the user program to be restarted appropriately after completion of the debug mode. Moreover, read of the contents of the internal register or the like can be realized using the commands which the monitor program has.

The control register is a register for controlling various kinds of debug processing, and it has, for example, a stepwise execution enable bit, a break enable bit, a break address bit, a trace enable bit, or the like. The CPU 50, which operates based on the monitor program, writes data to each bit of the control register, or reads data of each bit, thereby realizing various kinds of debug processing.

The pin-saving type debug tool 110 includes a second clock generation circuit 170 for generating a clock with the same baud rate as the first clock generation circuit 70, and a second asynchronous-communication control circuit 180, which carries out communication control for transmitting and receiving the debug data to/from the target system, through asynchronous type serial data transmission, with the clock generated in the second clock generation circuit 170 being as an operation clock.

The pin-saving type debug tool 110 includes a debug terminal 158, to which one communication line 262 for transmitting and receiving the debug data through half duplex bidirectional communication is coupled.

Here, the debug data includes, for example, debug commands to be transmitted to the target system from the debug module, and the data and status commands to be transmitted to the debug module from the target system.

The second asynchronous-communication control circuit 180 transmits and receives debug data to/from the pin-saving type debug tool 110, via the communication line 262, through half duplex bidirectional communication.

Moreover, a reference numeral 268 is a ground line for connecting the substrate (the user board) 40 to the debug tool 110.

According to the embodiment, the target system 10 and debug module 110 transmit and receive debug data through asynchronous serial data transmission at the time of debugging. Accordingly, it is not necessary to transmit and receive the clock used for synchronization like in the case of transmitting and receiving data through synchronous transmission at the time of debugging, and it is therefore not necessary to have the clock terminal for debugging.

In this way, according to the embodiment, because the count of terminals (pins), which are used only in the debug mode of the integrated circuit device having a built-in CPU and are not used in the user mode (in the user program), can be reduced, and thereby the cost increase of the integrated circuit device can be prevented.

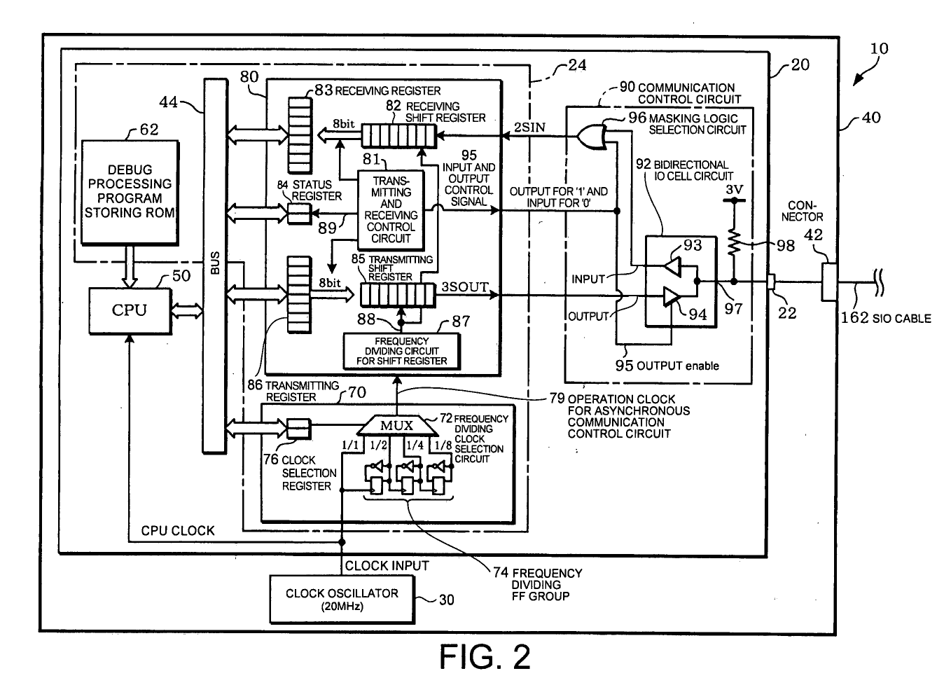

FIG. 2 is a view for explaining an example of the configuration of the target system of the embodiment.

The microcomputer 20 includes CPU 50, a first clock generation circuit 70, a first asynchronous-communication control circuit 80, SIO communication control circuit 90, a debug processing-program storing ROM 62, a bus 44, or the like.

CPU 50, the first clock generation circuit 70, and the first asynchronous-communication control circuit 80 are coupled to the bus 44.

The debug processing-program storing ROM 62 is coupled to CPU 50, and at the time of debugging, the CPU executes the debugging program, which is read from the debug processing-program storing ROM 62.

A connector 42 of the user board 40 is coupled to the debug tool via SIO communication line 162, and carries out half duplex bidirectional data communication at the time of debugging.

The SIO communication control circuit 90 includes a bidirectional IO cell circuit 92, a masking logic circuit 96, and a pull-up circuit 98. An external input or output is inputted to a buffer 93 of the bidirectional IO cell circuit 92. Moreover, a buffer 94 of the bidirectional IO cell circuit 92 serves as the output when the output enable is 1, and when the output enable is 0, it becomes high impedance to be in the condition of allowing external inputs.

Moreover, an input/output data line is coupled, between a debug SIO terminal 22 and a node 97, to a pull-up circuit 98 (for example, coupled to a 3V power supply via a 100 kΩ resistor), so that the input/output data line becomes H level in the condition of no communication.

Moreover, the masking logic circuit 96 is controlled by masking so that 1 (H level, for example) may be inputted, thereby not allowing the inputting to be started in the outputting condition.

The first asynchronous-communication control circuit 80 includes a transmitting and receiving control circuit 81, a receiving shift register 82, a receiving register (for example, 8 bit FF (flip prop)) 83, a status register (for example, 2 bit FF (flip prop)) 84, a transmitting shift register 85, a transmitting register (for example, 8 bit FF (flip prop)) 86, and a shift register frequency-dividing circuit 87, and it operates based on an operation clock which the first clock generation circuit 70 generates.

The shift register frequency-dividing circuit 87 divides the operation clock which the first clock generation circuit 70 generates. For example, a clock of 9600 bit/second, which the first clock generation circuit 70 generates as the operation clock, is divided by 16.

The receiving shift register 82 stores the SIO input (SIN) 2 sequentially, and judges the data based on the frequency-divided reference clock and stores it in the receiving register 83. The data stored in the receiving register 83 can be read from CPU 50 via the bus.

The values stored in a transmitting register 86 are stored serially in a transmitting shift register 85, and outputted sequentially as SOUT based on the frequency-divided reference clock. The data write is possible from CPU 50 to the transmitting register 86 via the bus.

In this way, the first asynchronous-communication control circuit carries out processing: of conversion of byte data, which comes from a parallel bus within the microcomputer, into a serial bit stream; and of conversion of a bit stream, which comes into the serial port via the SIO cable, into a parallel byte data which the computer can process.

Moreover, in addition to the conversion from serial to parallel, additional bits (the so-called start bit and stop bit) may be added to the respective byte before the byte data is transmitted.

The transmitting and receiving control circuit 81 generates an input/output control signal (1 (H level) for outputting and 0 (L level) for inputting). An input/output control signal 89 is set to a status register (with 2 bits, for example), and the status register (with 2 bits, for example) can be accessed from CPU. Moreover, the input/output control signal 89 serves as an output enable signal for the communication control circuit.

The first clock generation circuit 70 includes a frequency-dividing clock selection circuit 72, a frequency-dividing FF (flip prop) circuit 74, and a clock selection register 95.

A clock inputted from a clock oscillator 30 of the user board 40 is inputted to the frequency-dividing clock selection circuit (MUX) 72 and the frequency-dividing FF circuit 74. The frequency-dividing FF circuit 74 generates ½ frequency dividing clock, ¼ frequency dividing clock and ⅛ frequency dividing clock of the inputted clock, which are to be inputted to the frequency-dividing FF circuit 74, respectively.

The frequency-dividing FF circuit 74 selects a clock from the inputted clocks ( 1/1 clock, ½ frequency-dividing clock, ¼ frequency-dividing clock, ⅛ frequency-dividing clock) based on the value set to a clock selection register 76, and outputs it as the operation clock.

The clock selection register 76 can be accessed from CPU 50 via a bus.

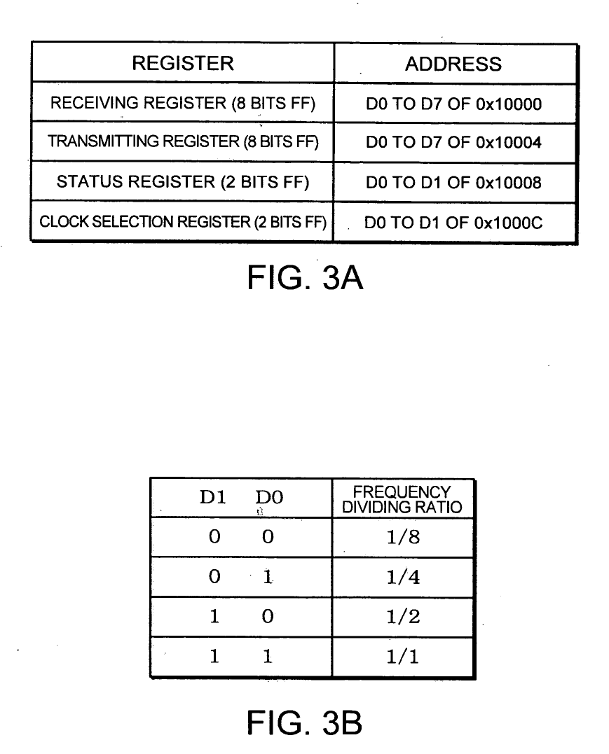

FIG. 3A is an example of address allocation for each register in the debug module, and FIG. 3B is a table showing an example of the relationship between values of the clock selection register and the frequency dividing ratio. The frequency-dividing clock selection circuit of the first clock generation circuit looks up to 2 bits of the address 0x000C as the values of D0 through D1 of the clock selection register value, and carries out ⅛ frequency-dividing if it is ‘00’, carries out ¼ frequency-dividing if it is ‘01’, carries out ½ frequency-dividing if it is ‘10’, and carries out 1/1 frequency-dividing if it is ‘11’. In addition, in order to make safe and low-powered, the default value may be set to ⅛ frequency dividing.

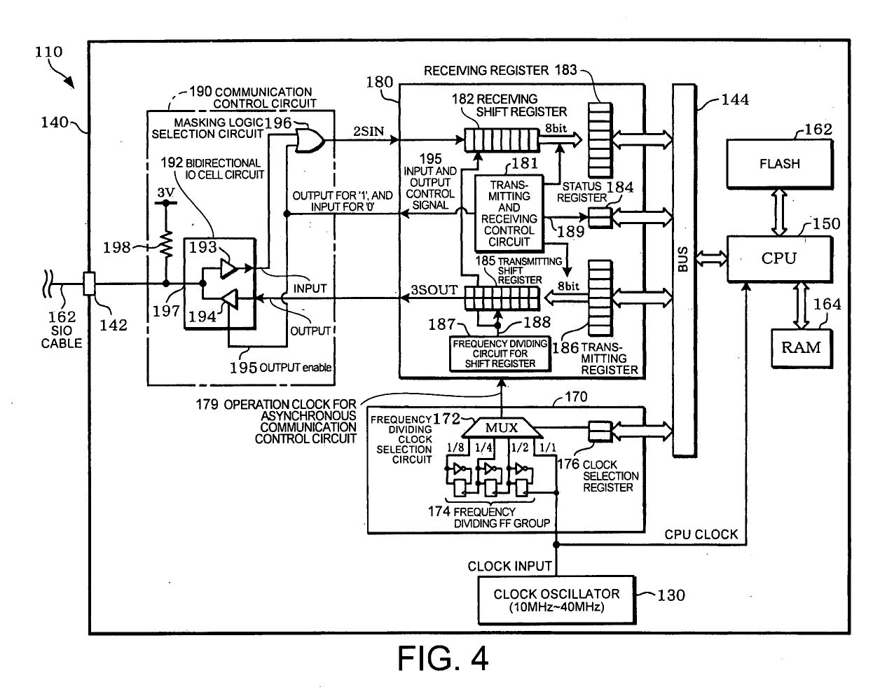

FIG. 4 is a view for explaining an example of the configuration of the debug tool of the embodiment.

A debug tool 110 includes CPU 150, a second clock generation circuit 170, a second asynchronous-communication control circuit 180, SIO communication control circuit 190, RAM (a working RAM) 164, a flash memory (an ICE control program is stored) 162, a variable oscillator 130, a bus 144, or the like.

CPU 150, the second clock generation circuit 170, and the second asynchronous-communication control circuit 180 are coupled to the bus 144.

The flash memory (the ICE control program is stored) 162 is coupled to CPU 150, and at the time of debugging, the CPU executes a debug module control program that is read from the flash memory 162.

An external terminal 142 of the debug tool 110 is coupled to the target system via a communication line 162, and carries out half-duplex bidirectional data communication at the time of debugging.

The SIO communication control circuit 190 includes a bidirectional IO cell circuit 192, a masking logic section 196, and a pull-up circuit 198. An external input or output is inputted to a buffer 193 of the bidirectional IO cell circuit 192. Moreover, a buffer 194 of the bidirectional IO cell circuit 192 serves as the output when the output enable is 1, and when the output enable is 0 it becomes high impedance to be in the condition of allowing external inputs.

Moreover, the input/output data line is coupled, between the terminal 142 and a node 197, to a pull-up circuit 198 (for example, coupled to a 3V power supply via a 100 kΩ resistor), so that the input/output data line becomes H level in the condition of no communication.

Moreover, the masking logic circuit 196 is controlled by masking so that 1 (H level, for example) may be inputted, thereby not allowing the inputting to be started in the output condition.

The second asynchronous-communication control circuit 180 includes a transmitting and receiving control circuit 181, a receiving shift register 182, a receiving register (for example, 8 bit FF (flip prop)) 183, a status register (for example, 2 bit FF (flip prop)) 184, a transmitting shift register 185, a transmitting register (for example, 8 bit FF (flip prop)) 186, and a shift register frequency-dividing circuit 187, and it operates based on an operation clock which the first clock generation circuit 170 generates.

The shift register frequency-dividing circuit 187 divides the operation clock which the second clock generation circuit 170 generates. For example, a clock of 9600 bit/second, which the second clock generation circuit 170 generates as the operation clock, is divided by 16.

The receiving shift register 182 stores the SIO input (SIN) sequentially, and judges the data based on the frequency-divided reference clock and stores it in the receiving register 183. The data stored in the receiving register 183 can be read from CPU 150 via the bus.

The values stored in the transmitting register 186 are stored serially in the transmitting shift register 185, and outputted sequentially as SOUT based on the frequency-divided reference clock. To the transmitting register 186, the data write is possible from CPU 150 via the bus.

The transmitting and receiving control circuit 181 generates an input/output control signal (1 (H level) for outputting and 0 (L level) for inputting). An input/output control signal 189 is set to a status register (with 2 bits, for example), and the status register (with 2 bits, for example) can be accessed from CPU. Moreover, the input/output control signal 195 serves as the output enable signal for the communication control circuit.

The first clock generation circuit 170 includes a frequency-dividing clock selection circuit 172, a frequency-dividing FF (flip prop) circuit 174, and a clock selection register 176.

A clock inputted from a variable oscillator 130 is inputted to the frequency-dividing clock selection circuit (MUX) 172 and frequency-dividing FF circuit 174. The frequency-dividing FF circuit 174 generates clocks, ½ frequency dividing clock, ¼ frequency dividing clock and ⅛ frequency dividing clock of the inputted clock, which are to be inputted to the frequency-dividing FF circuit 174, respectively.

The frequency dividing FF circuit 174 selects a clock from the inputted clocks ( 1/1 clock, ½ frequency-dividing clock, ¼ frequency-dividing clock, ⅛ frequency-dividing clock) based on the value set to a clock selection register 176, and outputs it as the operation clock.

The clock selection register 176 can be accessed from CPU 150 via a bus.

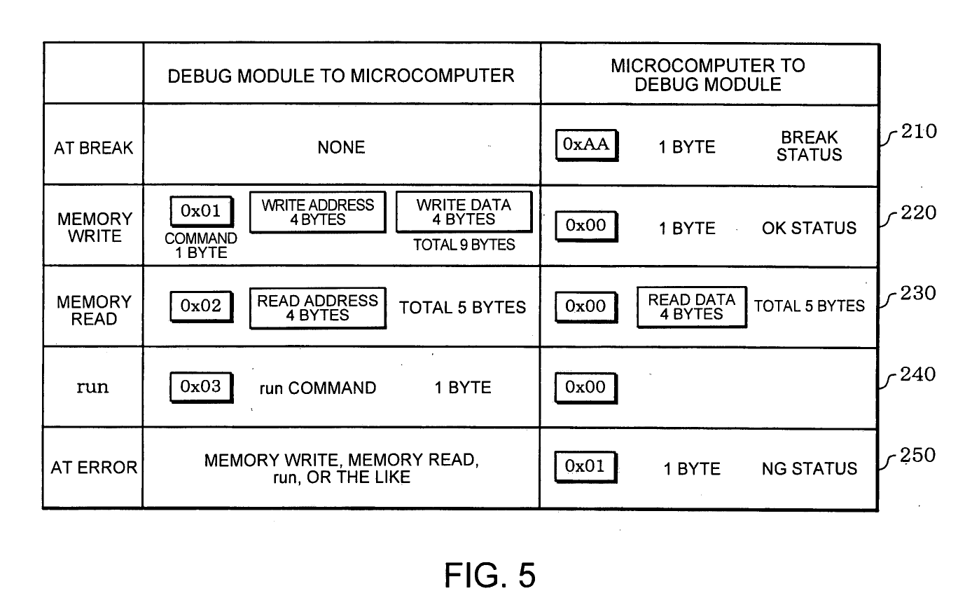

FIG. 5 is a view for explaining an example of a communication specification of debug commands of the embodiment.

In the embodiment, half-duplex bidirectional communication is realized by determining the byte count like, for example 8 bytes from the microcomputer to debug module, and for example 14 bytes from the debug module to the microcomputer under the predetermined standard (for example RS232C which is a standard for serial communication) for carrying out asynchronous communication and carrying out handshaking.

For example, at the time of a break, 1 byte of break status is transmitted to the debug module from the microcomputer (refer to 210).

Moreover, at the time of memory-write to the microcomputer, a debug command including a write command, a write address, and a write data is transmitted from the debug module to the microcomputer. Then, a write OK status is replied from the microcomputer (refer to 220).

Moreover, at the time of memory-read to the microcomputer, a debug command including a read command and a read address is transmitted from the debug module to the microcomputer. Then, a read data is replied from the microcomputer (refer to 230).

Moreover, at the time of RUN instruction to the microcomputer, a debug command including RUN command is transmitted from the debug module to the microcomputer. Then, a reply command is replied from the microcomputer (refer to 240).

Moreover, when an error occurs on the microcomputer side as a result of the memory write, the memory read, or the RUN command, a reply command including NG status is replied from the microcomputer (refer to 250).

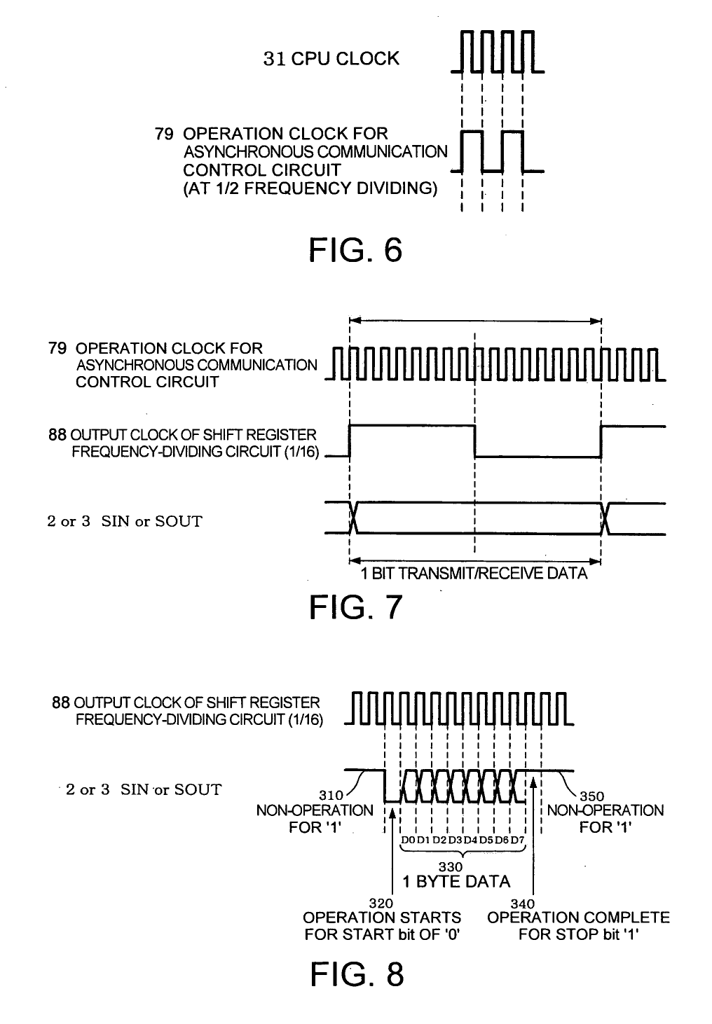

FIG. 6 is a timing chart indicating the relationship between CPU clock 31 and the asynchronous-control circuit clock 79 (at the time of ½ frequency dividing) of the embodiment.

FIG. 7 is a timing chart concerning the judgment of 1 bit of the transmitting and receiving data in the asynchronous-control circuit.

A reference numeral 79 refers to the an operation clock for asynchronous-communication control circuit, a reference numeral 88 refers to the output clock of the frequency dividing circuit used for shift register, and a reference numeral 2 or 3 refers to 1 bit of the transmitting and receiving data (SIN or SOUT). The frequency dividing circuit used for shift register of the asynchronous-control circuit frequency-divides by 16 the asynchronous-communication control-circuit operation clock 79, and outputs a reference numeral 88. The receiving shift register or transmitting shift register judges 1 bit of data based on the output clock 88 of this frequency dividing circuit used for shift register.

FIG. 8 is a timing chart concerning the judgment of 1 byte of the transmitting and receiving data in the asynchronous-control circuit. The reference numeral 88 refers to the output clock of the frequency dividing circuit used for shift register, and the reference numeral 2 or 3 refers to 1 bit of the transmitting and receiving data (SIN or SOUT). During a non-operating time of the both transmission and reception, SIN or SOUT is set to 1 (e.g. H level), (refer to 310), and with a start bit of 0 (e.g. L level) the operation is started (refer to 320) and the transmitting and receiving of 1 byte of data 330 are carried out, and for a stop bit of 1 (e.g. H level) the operation completes (refer to 340), and again the SIN or SOUT becomes 1 (e.g. H level) during the non-operating time.

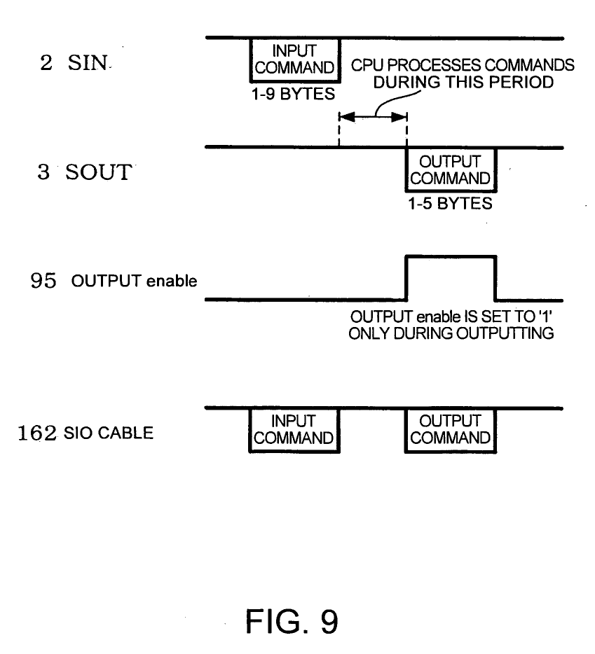

FIG. 9 is a timing chart concerning the input and output control of transmission and reception.

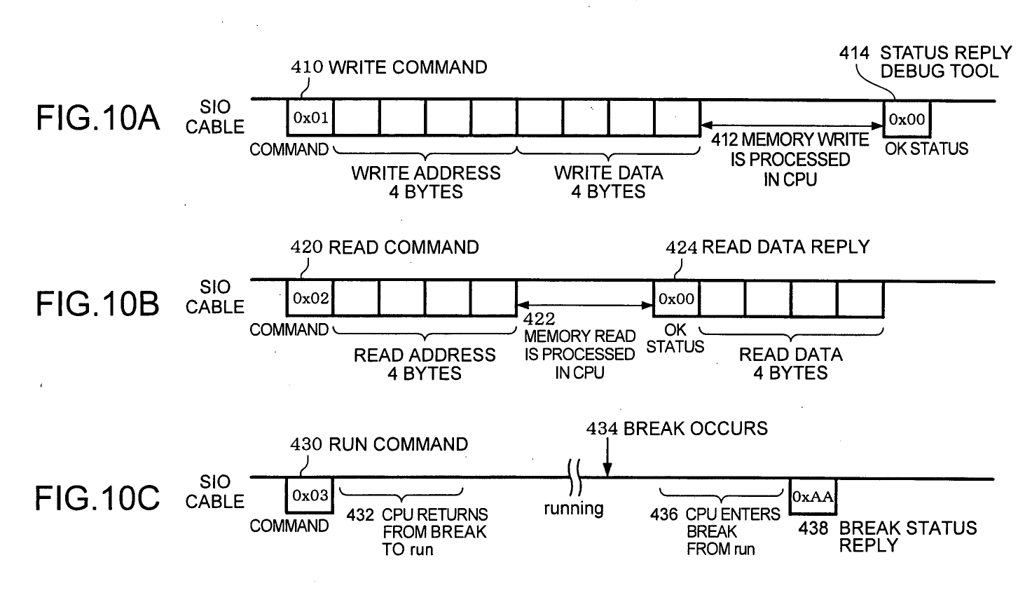

FIG. 10A through FIG. 10C are views showing an example of SIO operation for each command.

FIG. 10A is the command operation at the time of memory write, FIG. 10B is the command operation at the time of memory read, and FIG. 10C is the command operation at the time of run instruction.

At the time of memory write, a debug command for the write (including a write command, a write address, and write data) is transmitted from the debug tool to the microcomputer as shown in FIG. 10A (refer to a reference numeral 410), and after the memory write processing is carried out in the microcomputer (refer to 412), a status signal is transmitted from the microcomputer to the debug tool (refer to 414).

At the time of memory read, a debug command for the read (including a read command and a read address) is transmitted from the debug tool to the microcomputer as shown in FIG. 10B (refer to 420), and after the memory read processing is carried out in the microcomputer (refer to 422), the read data is transmitted from the microcomputer to the debug tool (refer to 424).

At the time of run instruction, as shown in FIG. 10C, a debug command for the run (including a run command) is transmitted from the debug tool to the microcomputer (refer to 430), and CPU of the microcomputer returns to the run condition from the break condition, and when a break occurs again (refer to 434), CPU of the microcomputer shifts from the run condition to the break condition, and the break status is transmitted to the debug tool from the microcomputer (refer to 438).

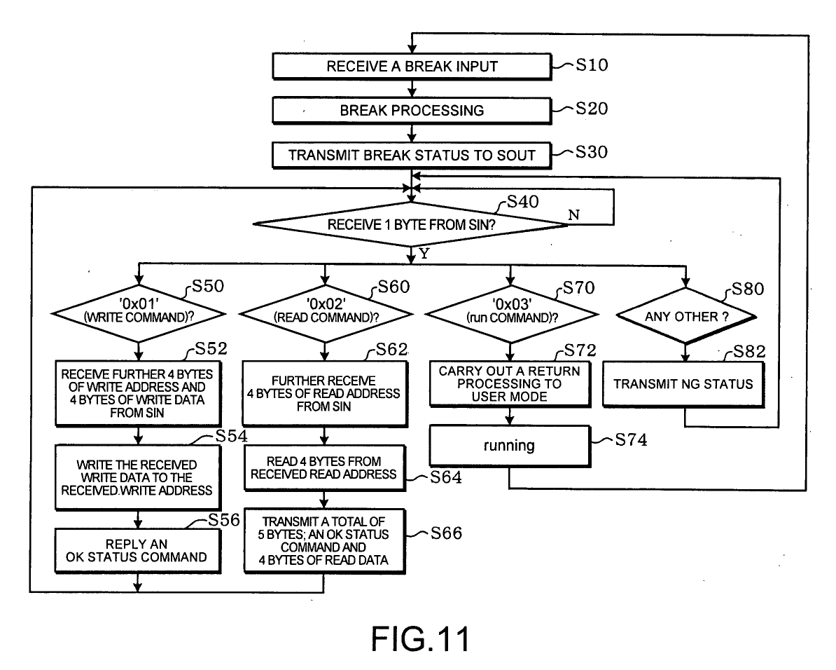

FIG. 11 is a flow chart of the operation at the time of debug processing in the microcomputer of the target system.

First, upon receipt of a break input (Step S10), a break processing (processing in which CPU shifts to the debug mode from the user mode) is carried out (Step S20). The break input may be received as an interrupt signal to the CPU.

When it shifts to the debug mode, a break status is transmitted to SOUT (Step S30). The break status of SOUT is transmitted to the debug tool via the SIO-communication line.

Next, upon receipt of 1 byte (a debug command) from the debug tool as SIN, the following processing will be carried out (Step S40).

In the case where the debug command is a write command, further 4 bytes of write address and 4 bytes of write data are received from SIN (Steps S50 and S52). Then, the received write data is written to the received write address (Step S54), and an OK status command is transmitted (Step S56).

In the case where the debug command is a read command, further 4 bytes of read address are received from SIN (Steps S60 and S62). Then, 4 bytes of data are read from the received read address (Step S64), and a status command and 4 bytes of read data are transmitted (Step S66).

In the case where the debug command is a RUN command, a return processing to the user mode is carried out (Steps S70 and S72), and it is ready for receiving a break input.

In the case where the debug command is other than the above described commands, an NG status command is transmitted (Steps S80 and S82).

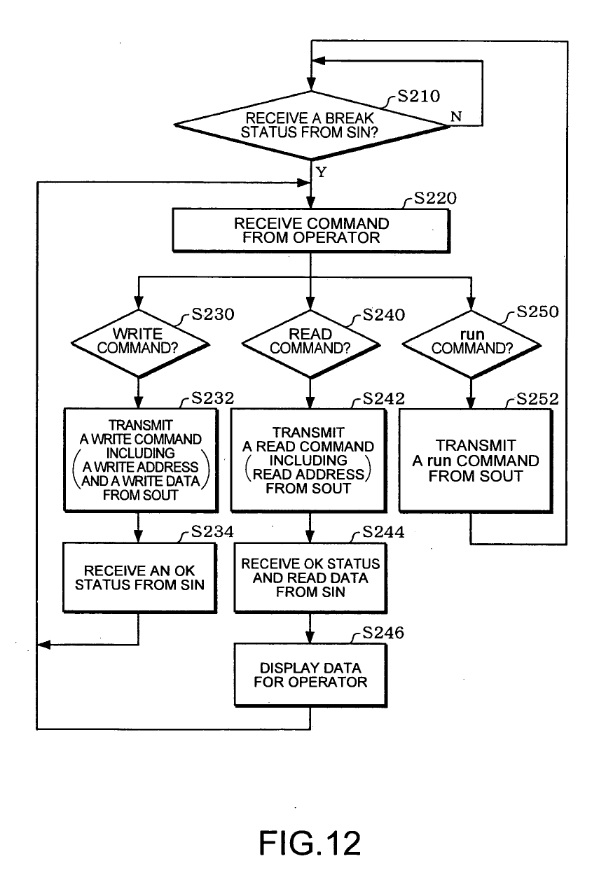

FIG. 12 is a flow chart of the operation at the time of debug processing in the debug tool.

If the microcomputer receives a break status from SIN during RUN in the user mode, the following processing will be carried out (Step S210).

First, a debug command to the debug module is received from an operator (Step S220).

In the case where the received command is a write command, a write command (including 4 bytes of write address and 4 bytes of write data) is transmitted from SOUT (Steps S230 and S232).

Then, an OK status is received from SIN (Step S234).

In the case where the received command is a read command, a read command (including 4 bytes of read address) is transmitted from SOUT (Steps S240 and S242).

Then, the OK status and 4 bytes of read data are received from SIN (Step S244), thereby displaying them for the operator (Step S246).

In the case where the received command is a RUN command, the RUN command is transmitted from SOUT (Steps S250 and S252).

Moreover, in the embodiment, the operation clock at the time of debugging may be configured as to be changeable. For example, the first clock generation circuit of the semiconductor integrated circuit device in the target system may include a first baud-rate change circuit, which frequency-divides the clock based on the clock selection value set from the outside and generates a clock with a predetermined baud rate, and the second clock generation circuit in the pin-saving type debug tool may include a second baud-rate change circuit, which frequency-divides the clock based on the clock selection value set from the outside and generates a clock with a predetermined baud rate.

The microcomputer of the embodiment, as explained in FIG. 3A and FIG. 3B, can change the operation clock to be supplied to the asynchronous-control circuit by changing the value to be set to the clock selection register. Because ‘00’ is set as the default value of the clock selection register (here, D0 and D1 of the address 0x000C), the asynchronous-control circuit will operate in ⅛ frequency dividing. For example, when the clock oscillator is at 20 MHz, the asynchronous-control circuit operates at the operation clock of 2.5 MHz=20/8 MHz, which is then frequency-divided by 16 in this operation-clock frequency dividing circuit used for shift register, and will be set at 156.25 Kbps (bit per second)=2.5/16 MHz. Because 10 bits (a start bit+data+a stop bit) are required for 1 byte of transmission and reception, the data transmission rate becomes 15.625 Kbytes/sec at the maximum.

For example, when desiring to attain speeding-up in the case where a large program of 1 M bytes or more is transmitted, the frequency dividing is switched from ⅛ to 1/1 or the like in the first clock generation circuit. This can be realized rewriting the clock selection register (here, D0, D1 of the address 0x000C) to ‘1, 1’. Then, the data transmission rate becomes 125 Kbytes/sec at the maximum, and 8 times speeding-up can be attained.

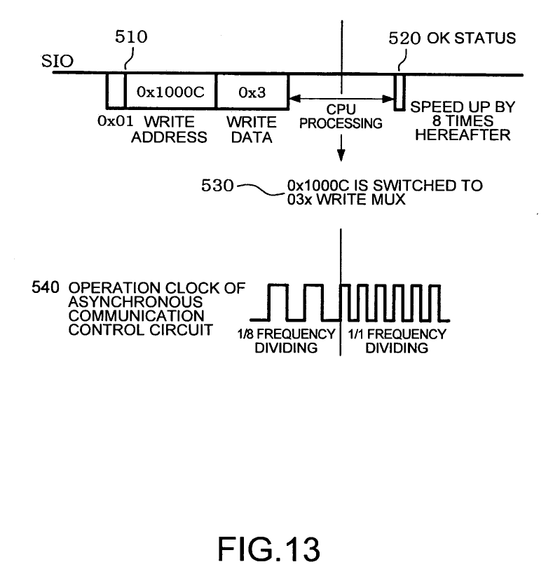

FIG. 13 is a view for explaining a baud-rate switching control for the communication data.

As shown in FIG. 13, there is shown a situation that when a write command for rewriting the value of the clock selection register is transmitted from the debug module to the microcomputer via SIO (refer to a reference numeral 510), the value of the clock selection register is rewritten by the CPU of the microcomputer, and the operation clock 540 of the asynchronous-communication circuit is changed to 1/1 frequency dividing from ⅛ frequency dividing. In addition, when the value of the clock selection register is rewritten by the CPU of the microcomputer, the microcomputer will reply the OK status to the debug tool.

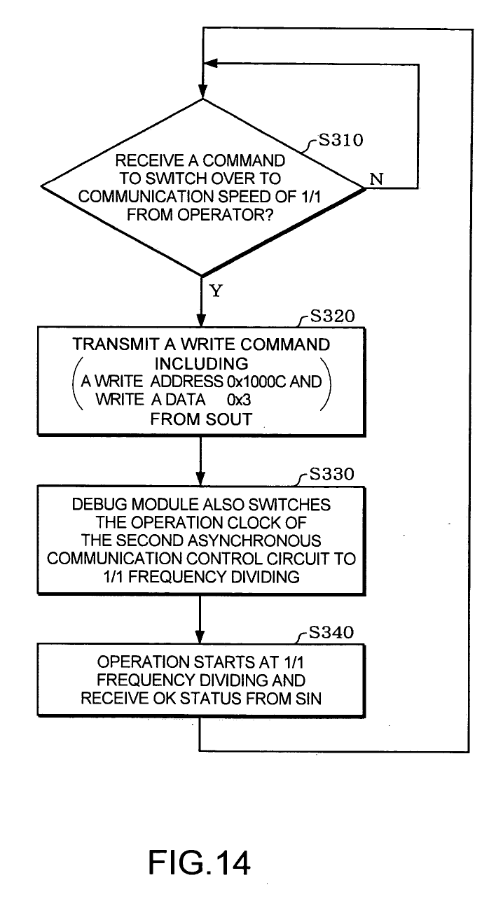

FIG. 14 is a flow chart of the switching operation of the operation clock in the debug tool.

Upon receipt of a switching command of the transmission speed from an operator, the following processing will be carried out (Step S310).

A write command (a write address 0x1000C and a write data 0x3) is transmitted from SOUT (Step S320).

The operation clock to be supplied to the second asynchronous-communication circuit of the debug module is also switched to 1/1 frequency dividing (Step S330).

The second asynchronous-communication circuit, in which the operation clock is also operation-started with 1/1 frequency dividing, receives the OK status from SIN (Step S340).

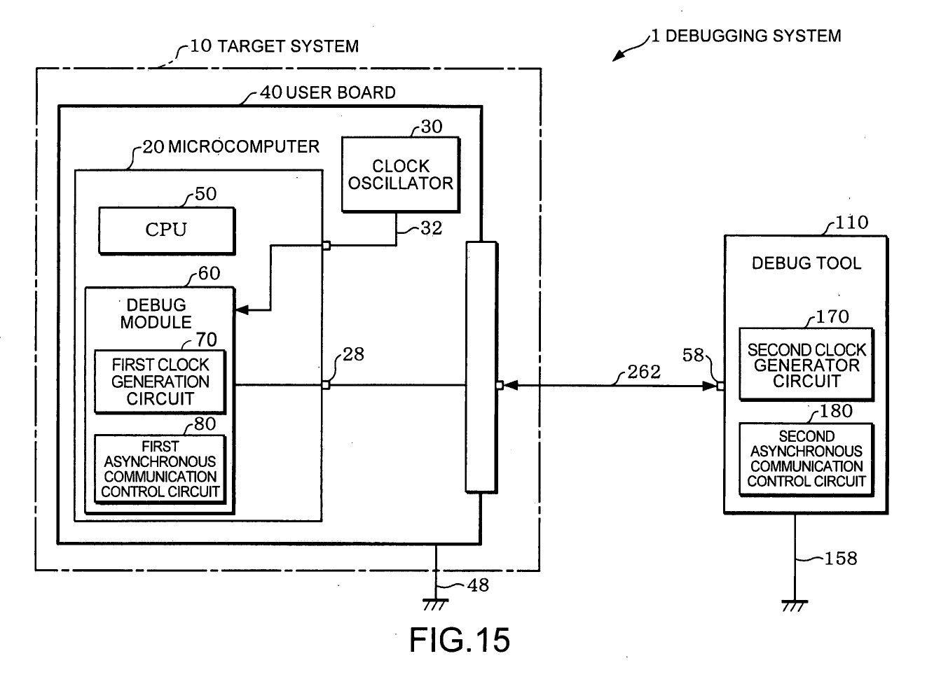

FIG. 15 is a view for explaining another configuration of a target system, a debugging system, and a microcomputer of the embodiment.

In this view, for those with the same numerals as FIG. 1, the description thereof will be omitted because of the same description as FIG. 1.

The embodiment of FIG. 15 does not have the ground line 268 of FIG. 1, and the substrate (the user board) 40 of the target system 10 and pin-saving type debug tool 110 are grounded (refer to reference numerals 48 and 158).

The substrate (the user board) 40 and debug tool 110 may be directly grounded, or may be indirectly grounded via a plug socket or the like.

In this manner, it is possible to omit the ground line, which connects the substrate (the user board) 40 of the target system 10 to the pin-saving type debug tool 110, thereby allowing the pin count of the substrate (user board) 40 to be reduced.

2. Microcomputer

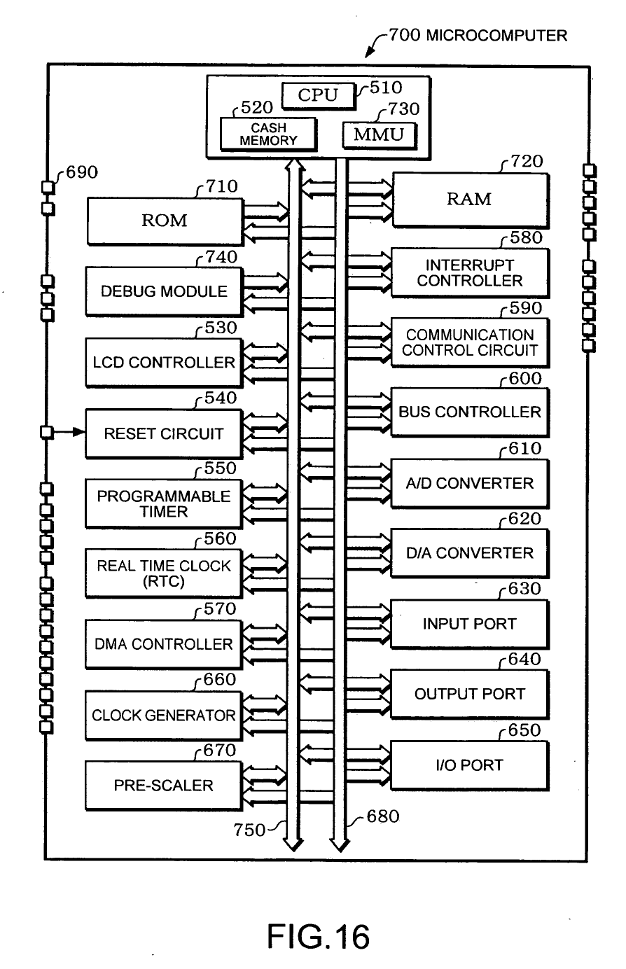

FIG. 16 is an example of a hardware block diagram of the microcomputer of the embodiment.

This microcomputer 700 includes CPU 510, a cache memory 520, RAM 710, ROM 720, MMU 730, LCD controller 530, a reset circuit 540, a programmable timer 550, a real-time clock 560 (RTC), DRAM controller 570, an interrupt controller 580, a communication controller (a serial interface) 590, a bus controller 600, AID converter 610, D/A converter 620, an input port 630, an output port 640, I/O port 650, a clock generator 660, a pre-scaler 670, a general-purpose bus 680 for coupling them, a debug module 740, a special purpose bus 750 or the like, various kinds of pins 690, or the like.

The debug module 740 has the configuration explained in FIG. 2.

3. Electronic apparatus

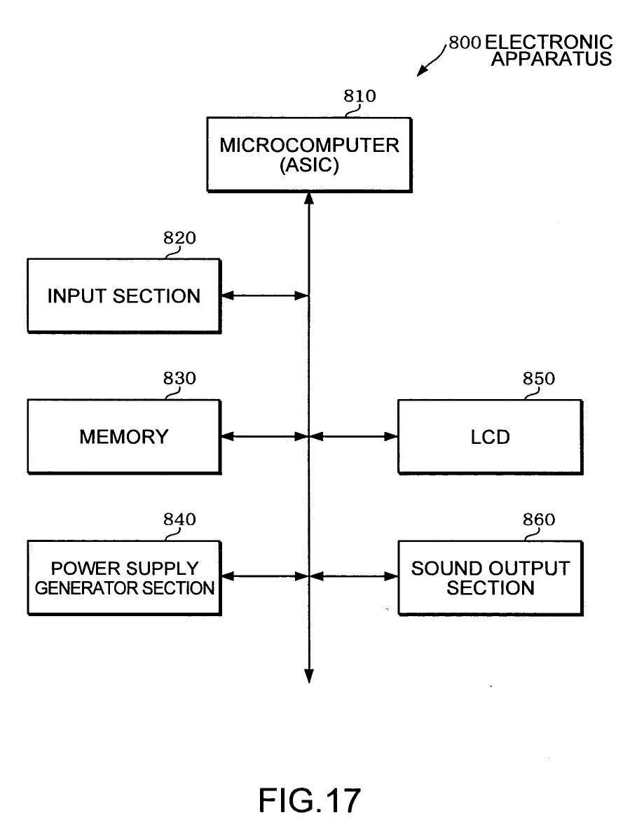

An example of the block diagram of electronic apparatus of the embodiment is shown in FIG. 17. This electronic apparatus 800 includes a microcomputer (or ASIC) 810, an input section 820, a memory 830, a power supply generation section 840, LCD 850, and a sound output section 860.

Here, the input section 820 is for inputting various data. The microcomputer 810 will carry out various processing based on the data inputted through this input section 820. The memory 830 serves as the work area for the microcomputer 810 or the like. The power supply generation section 840 is for generating various kinds of power supplies to be used in the electronic apparatus 800. LCD 850 is for outputting various kinds of pictures (characters, icons, graphics, or the like) which the electronic apparatus displays. The sound output section 860 is for outputting various kinds of sound (voice, game sound, or the like), which the electronic apparatus 800 outputs, and the function thereof can be realized with hardware, such as a loudspeaker.

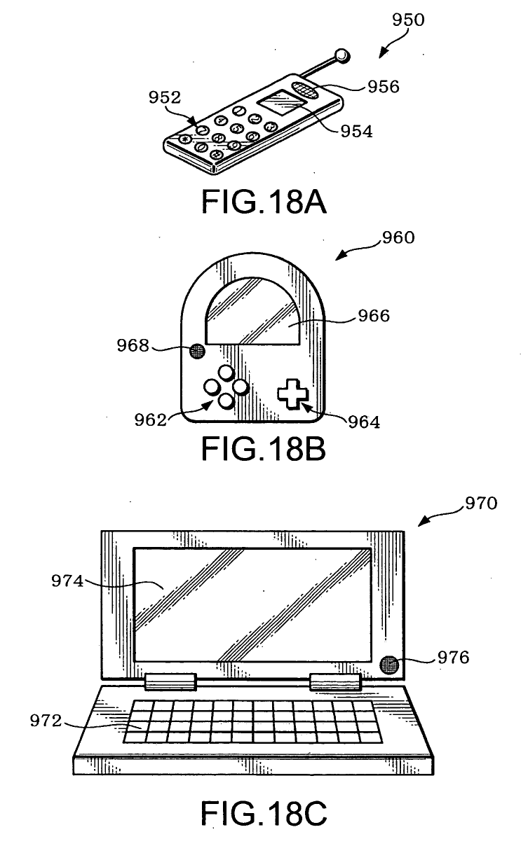

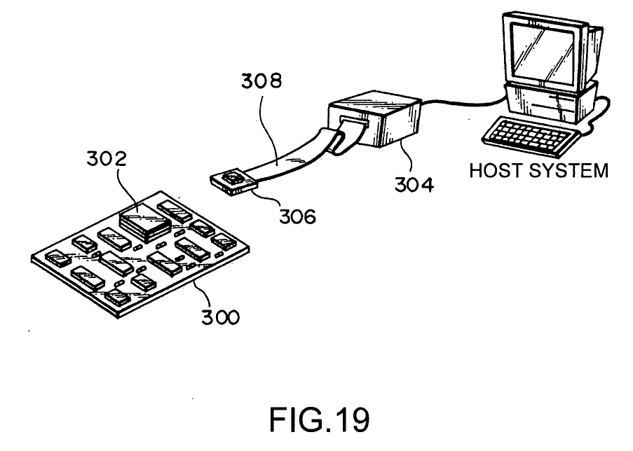

In FIG. 18A, there is shown an example of the outline view of a cellular phone 950, which is one of the electronic apparatus. This cellular phone 950 comprises a dial button 952 to function as an input section, LCD 954 to display telephone numbers, names, icons, or the like, and a loudspeaker 956 to function as a sound output section and output voices.

In FIG. 18B, there is shown an example of the outline view of a portable type game device 960, which is one of the electronic apparatus. This portable type game device 960 comprises an operation button 962 to function as an input section, a cross key 964, LCD 966 to display game pictures, and a loudspeaker 968 to function as a sound output section and output game sounds.

In FIG. 18C, there is shown an example of the outline view of a personal computer 970, which is one of the electronic apparatus. This personal computer 970 comprises a keyboard 972 to function as an input section, LCD 974 to display characters, numbers, graphics, or the like, and a sound output section 976.

By incorporating the microcomputer of the embodiment in the electronic apparatus of FIG. 18A through FIG. 18C, electronic apparatus with a fast image-processing speed and high cost performance can be provided at low price.

Note that, as the electronic apparatus in which the embodiment can be used, various electronic apparatus using LCD, such as a personal digital assistant, a pager, an electronic calculator, a device provided with a touch panel, a projector, a word processor, a view finder type or monitor direct viewing type video tape recorder, and a car navigation device, can be conceivable in addition to those shown in FIG. 18A, FIG. 18B, and FIG. 18C.

In addition, the invention is not restricted to the above-described embodiments, and various modifications can be implemented within the spirit and scope of the invention.

What is claimed is:

1. A debugging system, comprising a pin-saving type debug tool and a target system to be a debug target of the debug tool, the target system including: an integrated circuit device incorporating a CPU and an inner debug module, the inner debug module having a function to carry out asynchronous communication with the pin-saving type debug tool thereby to carry out on-chip debugging, wherein the integrated circuit device includes:
a first clock generation circuit; and
a first asynchronous-communication control circuit that carries out communication control for carrying out transmission and reception of debug data to/from the pin-saving type debug tool, through asynchronous type serial data transmission, with a clock generated in a first clock generation circuit being as an operation clock, and wherein the pin-saving type debug tool includes:
a second clock generation circuit that generates a clock with the same baud rate as that of the first clock generation circuit; and
a second asynchronous-communication control circuit that carries out the transmission and reception of debug data to/from the target system, through asynchronous type serial data transmission, with a clock generated in the second clock generation circuit being as an operation clock.

2. The debugging system according to claim 1, wherein
the integrated circuit device of the target system includes a debug terminal, to which one communication line for transmitting and receiving the debug data through half duplex bidirectional communication is coupled,
the first asynchronous-communication control circuit carries out communication control for transmitting and receiving the debug data, through half duplex bidirectional communication, via the pin-saving type debug tool and the communication line,
the pin-saving type debug tool includes a debug terminal, to which one communication line for transmitting and receiving the debug data through half duplex bidirectional communication is coupled; and
the second asynchronous-communication control circuit carries out communication control for transmitting and receiving the debug data, through half duplex bidirectional communication, via the integrated circuit device and the communication line.

3. The debugging system according to claim 1, wherein
the first clock generation circuit of the integrated circuit device of the target system includes a frequency dividing circuit that divides a clock and generates a clock with a predetermined baud rate based on a clock selection value, which can be set or changed from the outside; and
the second clock generation circuit of the pin-saving type debug tool includes a frequency dividing circuit that divides a clock and generates a clock with a predetermined baud rate based on a clock selection value, which can be set or changed from the outside.

4. The debugging system according to claim 1, wherein a general-purpose UART incorporated in the integrated circuit device is used as the first asynchronous-communication control circuit of the integrated circuit device.

5. The debugging system according to claim 1, wherein the first asynchronous-communication control circuit of the integrated circuit device and the second asynchronous-communication control circuit of the pin-saving type debug tool operate handshaking under a predetermined standard.

6. The debugging system according to claim 1, wherein a substrate of the target system and the pin-saving type debug tool are grounded.

7. An integrated circuit device according to claim 1.

8. A microcomputer comprising the integrated circuit devices according to claim 1.

9. Electronic apparatus, comprising: the microcomputer according to claim 8; an input source of data to be a processing target of the microcomputer; and an output device for outputting the data processed by the microcomputer.
